(19) United States
(12) Patent Application Publication
(10) Pub. No.: US 2011/0215169 A1
(43) Pub. Date: Sep. 8, 2011

(54) Oscillating Fan Sprayer

(76) Inventor: Anthony David Denton, Bundaberg (AU)

(21) Appl. No.: 13/038,500

(22) Filed: Mar. 2, 2011

(30) Foreign Application Priority Data
Mar. 3, 2010 (AU) AU 2010900890

(51) Int. Cl. A01M 7/00; F04D 25/10; B05B 3/02

(52) U.S. Cl. 239/77; 416/98; 239/214

(57) ABSTRACT

A fan assembly includes a centrifugal fan mounted at one end of an arm that is arranged to pivot with at least two degrees of rotational freedom. A rotary driver is coupled to the arm with a ball and socket joint so that the centrifugal fan oscillates in use. The fan assembly may be configured as an orchard sprayer to disburse pesticide into foliage and be mounted to, or towed by, an agricultural vehicle. In use the motion of the fan assists in opening up foliage for improved penetration of the pesticide therein.

### TECHNICAL FIELD

The present invention relates to fans. Particular applications of the invention include fans for applying liquid solutions, such as insecticide, in agricultural settings.

### BACKGROUND

Embodiments of the present invention will be primarily described in relation to its use with tree sprayers. However, the invention is not limited in applicability a tree sprayer and may be used in other contexts as well.

There are many tree sprayers available in the marketplace for applying insecticides to trees in orchards. Typically these tree sprayers make use of axial fans having three to five blades. The fans may be hydraulically driven or incorporate electric motors so that they are electrically powered, for example. In some arrangements the fans are positioned high up and angled downward onto the tree in use. Alternatively, other arrangements position the fans beneath the tree branches and attempt to deliver insecticide laden air into the tree from below. One problem that such arrangements face is that since tree branches and leaves are usually naturally water shedding, the tree tends to repel the application of the solution.

Typically, prior art fans currently on the market gain limited entry of their airflow into the tree because their air stream tends to partially blow the tree shut, thereby preventing access into the body of the tree foliage.

The inventor has realized that to successfully spray trees with insecticides and pesticides an operator needs to replace the air in a tree with new air that is laden with chemical. It is an object of the present invention to provide an apparatus that will assist in more successfully replacing the air in a tree than has hitherto been possible.

### SUMMARY OF THE INVENTION

According to a first aspect of the present invention, there is provided a fan assembly including:
a support arm mounted to a pivot assembly having at least two degrees of rotational freedom;
a fan mounted to the support arm; and
a rotary driver coupled to the support arm for movement thereof about the pivot assembly.

Preferably the fan is mounted to a first end of the support arm and the rotary driver is coupled to the support arm at an opposite second end of the support arm with the pivot assembly located between said first and second ends.

In a preferred embodiment the pivot assembly includes first and second pivot axles.

Preferably the first and second pivot axles are orthogonal to each other.

In the preferred embodiment the pivot assembly is coupled to a frame of the fan assembly via the first axle and the support arm is mounted to the pivot assembly via the second axle.

Preferably the rotary driver is coupled to the support arm with a ball and socket joint.

One part of the ball and socket joint is preferably arranged to orbit a drive shaft of the rotary driver.

Preferably the drive shaft comprises a first output shaft from a gear box.

An input shaft of the gear box may be arranged for driving by a hydraulic motor arranged for fluid connection to a hydraulic system of a towing vehicle.

Alternatively the driver shaft may comprises part of, or be driven by, an electric motor.

Preferably the fan comprises a centrifugal fan.

Fluid outlets, such as nozzles, may be located about an air stream outlet side of the fan for dispersing fluid into said air stream during use.

According to a further aspect of the invention, there is provided an orchard sprayer for mounting to, or towing behind, an agricultural vehicle and including at least one fan assembly of the type described.

Preferably the orchard sprayer includes two opposed fan assemblies driven by a common power source.

In the preferred embodiment the common power source comprises a gearbox arranged for coupling to a power take off of an agricultural vehicle.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a first perspective view of an orchard sprayer incorporating fan assemblies and according to a preferred embodiment of the present invention.

FIG. 2 is a top plan view of the orchard sprayer of FIG. 1 without nozzles fitted.

FIG. 3 is a rear view of the orchard sprayer of FIG. 1 without nozzles fitted.

FIG. 4 is a side view of the orchard sprayer of FIG. 1 without nozzles fitted.

FIG. 5 is a detail view of a portion of FIG. 1.

FIG. 6 is a further detail view of a portion of FIG. 1.

FIG. 7 is a detail view of a pivot assembly shown in FIG. 1.

FIG. 8 is a second perspective view of the orchard sprayer drawn in a further stage of operation and without nozzles fitted.

FIG. 9 is a view of the rear of a fan assembly according to a preferred embodiment of the present invention, with spray nozzles fitted.

FIG. 10 is a view of the front of the fan assembly of FIG. 9.

FIG. 11 is a detail view of a circled portion of FIG. 9.

FIG. 12 is a detail view of a circled portion of FIG. 10.

FIG. 13 is a further view of the circled portion of FIG. 9, viewed from a different angle.

FIG. 14 is a view of a partially assembled orchard sprayer according to a preferred embodiment of an aspect of the present invention.

FIG. 15 is a diagram showing hydraulic and mechanical power circuits for the orchard sprayer of FIG. 14.

### DETAILED DESCRIPTION OF PREFERRED EMBODIMENTS

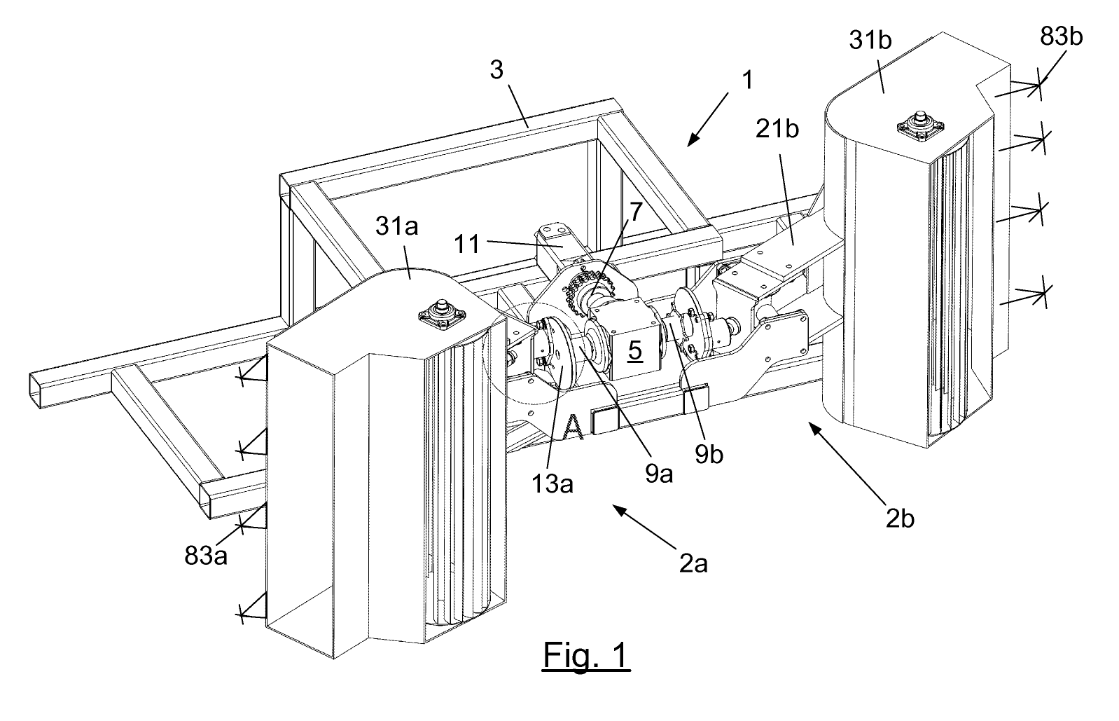

Throughout this description of the first embodiment of FIGS. 1 to 8, item numbers for components on the left hand side will end with an “a” and item numbers for components on the right hand side will end with a “b”. Reference will be made to components from either side to explain the structure and working of the fan assembly, depending on ease of visibility in the drawings.

FIG. 1 depicts a fan assembly 1 according to a first embodiment of the present invention. FIG. 6 is a detailed view of a circled portion of FIG. 1. The fan assembly 1 is fitted with nozzles 83a, 83b for dispersing droplets of insecticide solution into the air flow of fans 31a, 31b so that it may be used as an orchard sprayer for example.

The nozzles are fed by a pump that forces the solution through them from a reservoir mounted on the frame or on the tractor, as will be described in more detail later.

A frame 3 is provided which in use is mounted to, or configured as a trailer and towed behind, an agricultural vehicle such as a tractor.

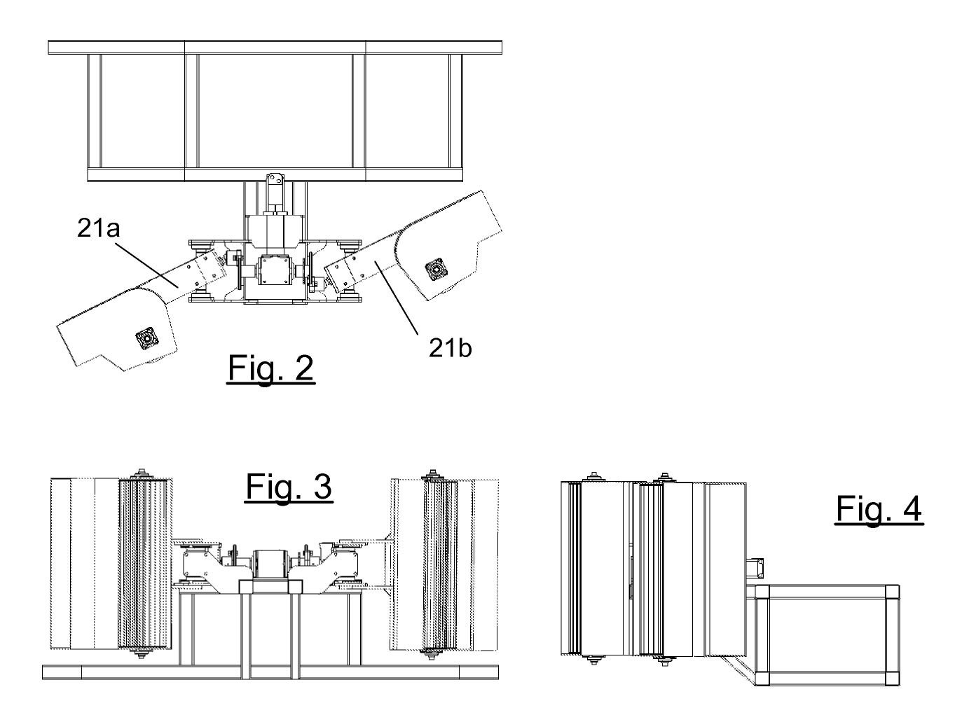

The fan assembly 1 includes left and right hand side fan assemblies 2a and 2b, which are substantially mirror images of each other. FIGS. 2 to 4 shown the orchard sprayer in top, rear and side plan view respectively.

Referring again to FIG. 1, mounted to the frame 3 there is a gear box 5 having an input shaft 7 and left and right output shafts 9a and 9b. As will be explained, the left output shaft 9a drives the left hand side fan assembly 2a and similarly the right hand output shaft 9b drives the right hand side fan assemby 2b. The input shaft 7 is coupled to the output shaft of a hydraulic motor 11 that in use is connected to and powered by the hydraulic system of a towing vehicle such as a tractor.

Fixed to the distal end of output shaft 9a there is a drive plate 13a, (best seen in the close up of FIG. 6). A socket 15a of a ball and socket joint is mounted off-centre to the outside of the drive plate. As may be seen in FIG. 6, the socket 15a may be repositioned by bolting it more or less off centre to the drive plate by means of bolt holes 17a, which are provided for that purpose.

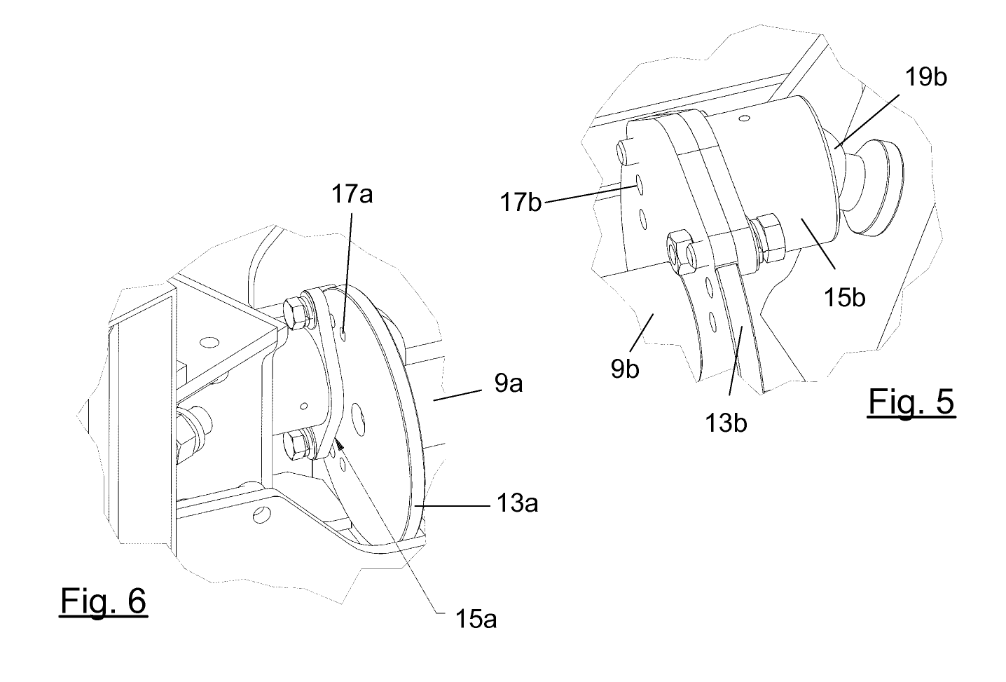

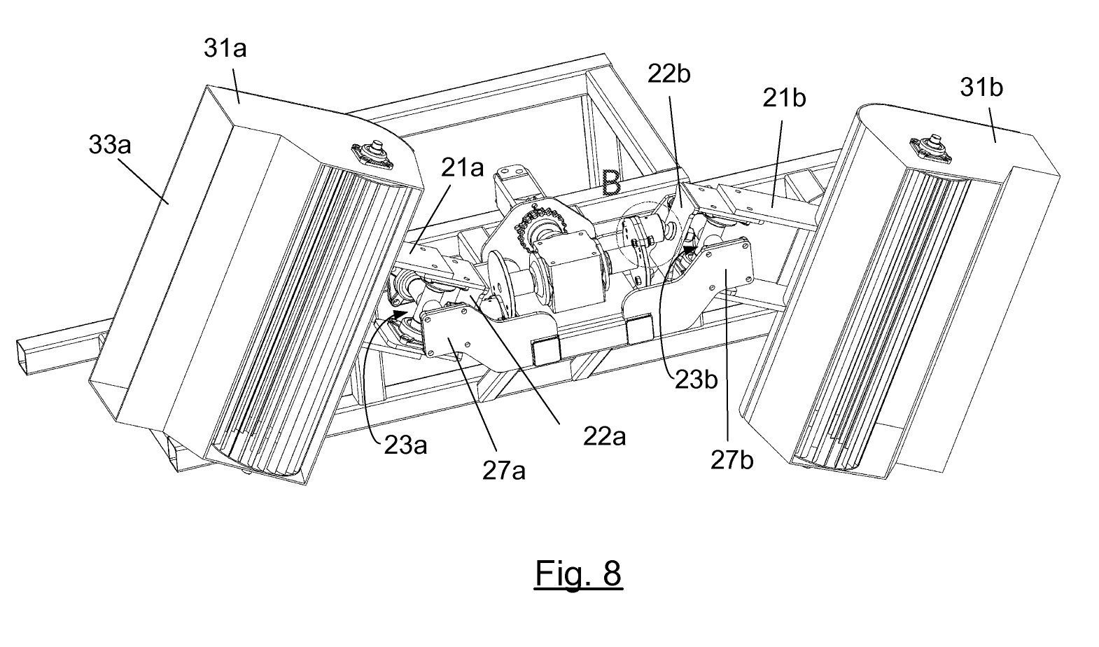

Referring now to FIG. 5, socket 15b engages ball 19b to thereby form a ball and socket joint. The ball 19b is mounted to a first, inner, end of support arm 21b. The support arm is mounted to frame 3 by a pivot assembly 23b (indicated in FIG. 8). The shaft 9b, drive plate 13b and socket 15b comprise one form of a rotary driver for driving the ball 19b, and hence the support arm 21b of the fan assembly.

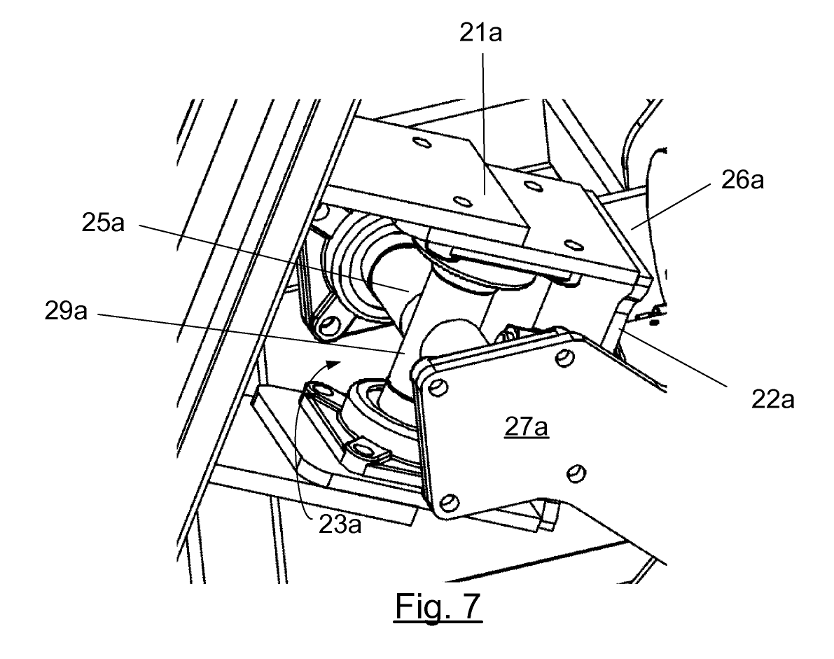

With reference to FIG. 7, the pivot assembly 23a includes a first axle 25a pivotally mounted between brackets 27a and 26a. The brackets are in turn fastened to frame 3. A second axle 29a intersects the first axle orthogonally. Support arm 21a, is pivotally mounted to the second axle 29a. It will therefore be realised that the first and second axes allow the support arm to move with two degrees of rotational freedom relative to the frame 3.

Other arrangements for mounting the support arm are possible. For example, a less preferred arrangement might involve using a ball and socket joint to mount the support arm.

Reference will now be made to FIG. 8, which shows the arms 21a, 21b once drive plates 13a, 13b have rotated through a further 90° C. relative to their positions in FIG. 1. At a remote end of the support arm 21b, opposite ball 19b there is mounted a centrifugal, or as it is sometimes called “squirrel cage”, fan 31b. The centrifugal fan is preferably hydraulically powered by the tractor's hydraulic power system. In alternative embodiments other types of fan may be used. For example, electrically powered fans might be used instead.

Referring again to FIG. 1, in use, input shaft 7 is rotated by the power take off from the tractor, which is connected to coupler 11. Consequently, output shafts 9a and 9b, and so drive plates 13a and 13b rotate in opposite directions. Off-centre sockets 15a and 15b orbit the axes of output shafts 9a and 9b respectively and thereby crank their respective balls 19a and 19b. In response, support arms 21a and 21b are swung up and down, forward and backward about their respective pivot assemblies 23a and 23b so that they roll and yaw about axles 25a, 25b and 29a, 29b respectively. As the support arms 21a and 21b swing they in turn move fans 31a and 31b so that the fans also roll and yaw about axles 25 and 27 respectively. If desired, sockets 15a, 15b may be repositioned by using bolt holes 17a, 17b on drive plates 13a, 13b in order to move the sockets more or less off-centre to drive shafts 15a, 15b, thereby increasing or decreasing the range of motion of fans 31a, 31b.

It will be noted from FIG. 1 and FIG. 8, which show the fan assembly at various points during its operational cycle that the sockets 15a and 15b are mounted so as to be 180 degrees out of phase with each other. As a result, in use fan 31b rises and moves forward while fan 31a falls and moves backward so that the forces associated with the motion of the fans tend to counteract each other thereby improving the stability of the orchard sprayer.

Referring again to FIG. 8, it may be noted that brackets 27a and 27b tend to limit the range of rotational movement of the arms 21a and 21b since they interfere with the inner ends 22A, 228 of the arms 21a and 21b.

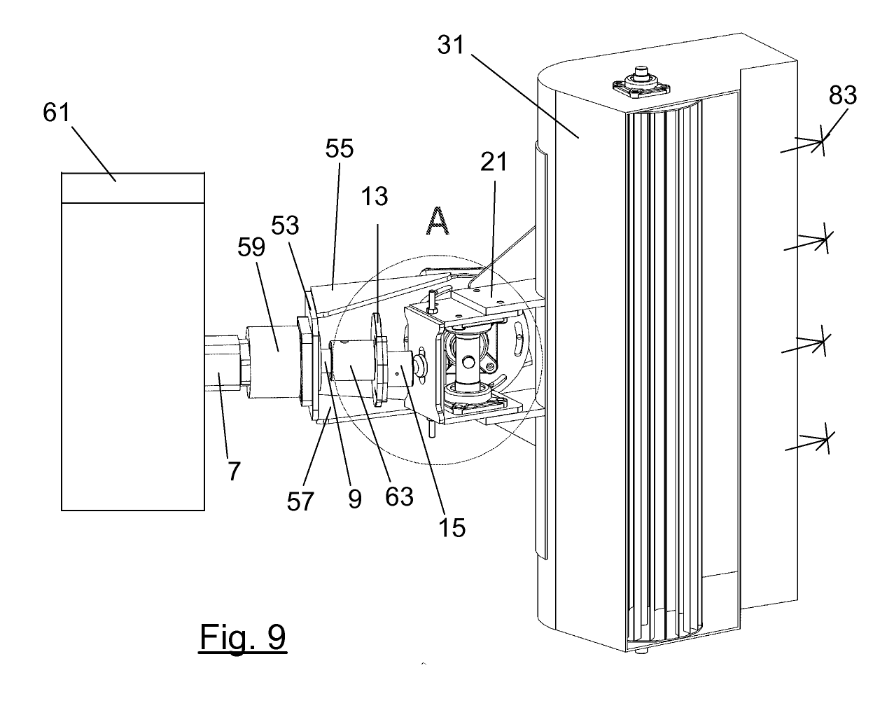

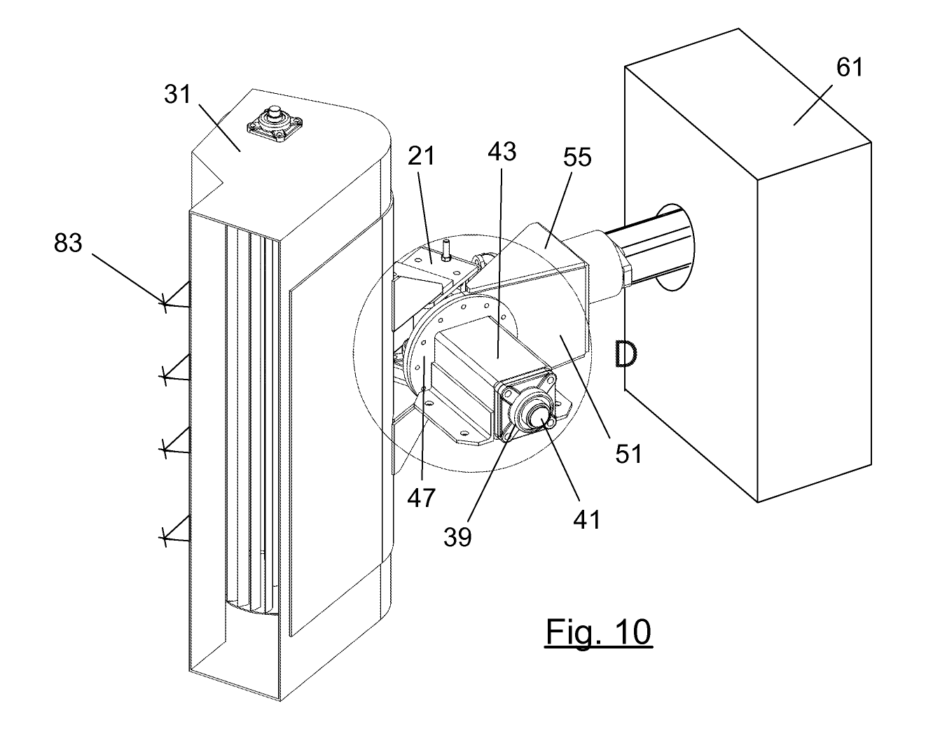

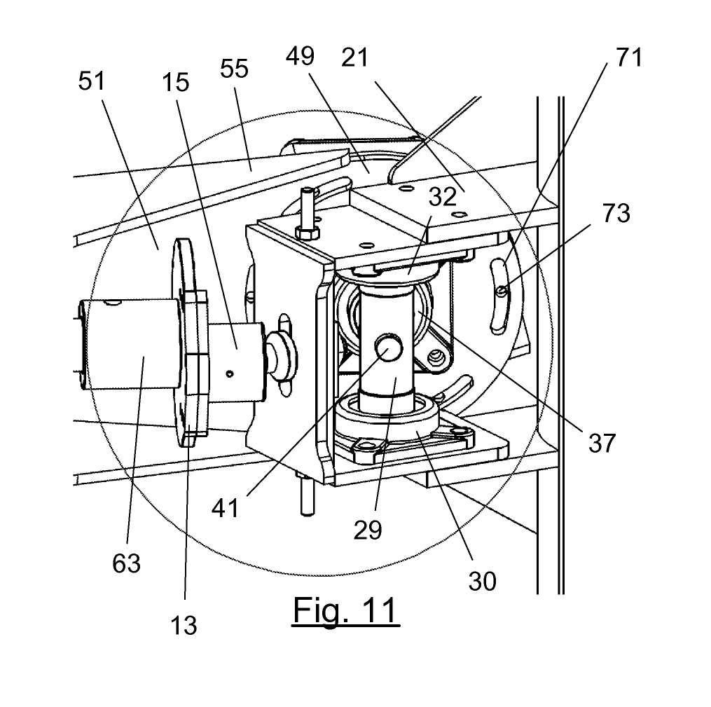

A preferred embodiment of the invention, which addresses this problem, is shown in FIGS. 9 to 13 wherein like components to those of the previously described embodiment share common identifiers.

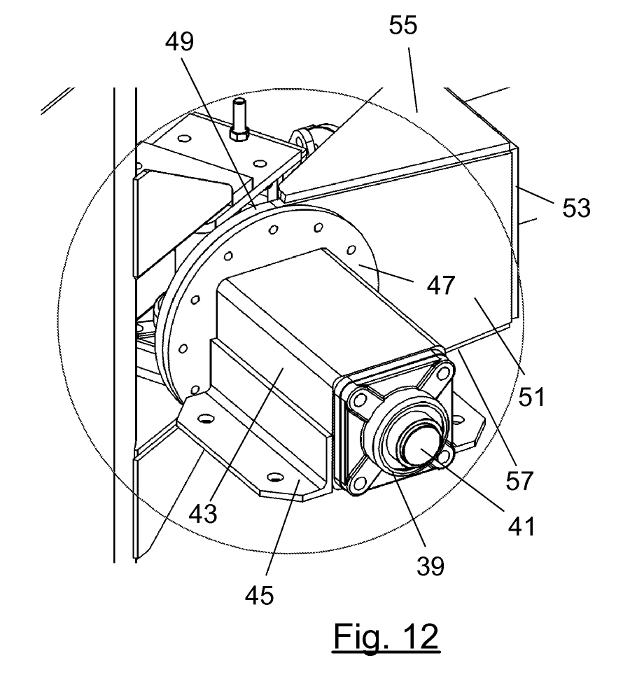

FIG. 9 is a view of the rear of a fan assembly according to the second embodiment of the invention. The circled area labelled “A” is shown in detail in FIG. 11. A series of nozzles 83 are fitted down the air exit side of the centrifugal fan 31. In use the nozzles have a chemical solution forced through them so that droplets of the solution are forced into air exiting the fan for application to orchards, for example.

Mounted to a baseplate 53 there is a step down, helical drive, gear box 59 which is coupled between an input shaft 7 and output shaft 9. In use the input shaft 7 is coupled to the drive shaft of a hydraulic motor 61 that is connected to the hydraulic circuit of a vehicle such as a tractor.

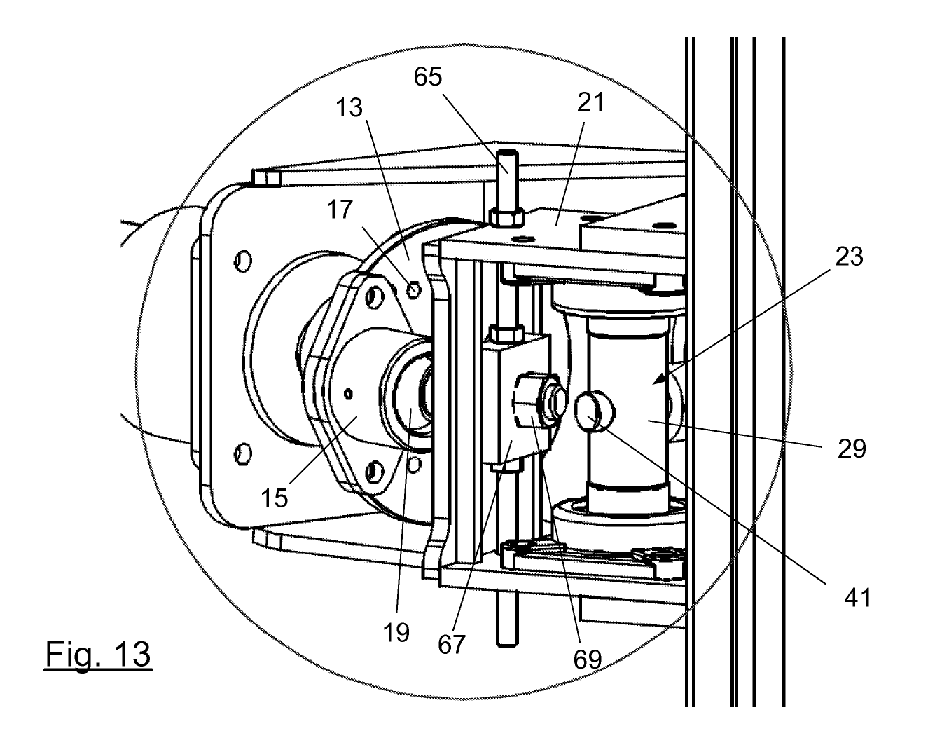

The output shaft 9 is coupled, by means of adaptor 63 to a drive plate 13. A socket 15 of a ball and socket joint is mounted off-centre to the outside of the drive plate as can be best seen in FIG. 13. As may be seen in FIG. 13, the socket 15 may be repositioned by bolting it more or less off centre to the drive plate by means of bolt holes 17, which are provided for that purpose.

With reference to FIG. 13, socket 15 engages ball 19 to thereby form a ball and socket joint. The ball 19 is mounted to a first, inner, end of support arm 21 by means of a mounting block 67 (visible in FIG. 13) which slides on rod 65. The other end of the support arm 21 supports a radial fan 31.

The height of the ball 19 may be adjusted by sliding it up and down rod 65 and then tightening bolt 69 to thereby fasten the mounting block in its desired location.

In the first embodiment, the pivot assembly 23a was cruciform since the first and second axles (25a, 29a of FIG. 7) intersected at their midpoints. Furthermore, axis 25a was suspended between the bracket arms 26 and 27. In contrast, in the second embodiment the pivot assembly is “T” shaped with the long axis of the “T” comprising a first axle 41 and the cross-bar of the “T” comprising axle 29. The first axle 41 is supported by spaced bearing assemblies 37 and 39.

Referring now to FIGS. 10, 11 and 12, bearing assembly 39 is located at a forward end of mounting box 43 as shown in FIG. 12.

Right angled sections 45 are fastened along opposite sides of mounting box 43 for mounting the box to a suitable support such as a frame of an agricultural vehicle or trailer.

A circular flange 47 is fixed fast to the rear end of mounting box 43. A mounting plate 51 terminates in a semicircular portion 49 which has a radius corresponding to that of flange 47 and which is located coaxial with the flange 47. The plate 51 terminates in the right angled base plate 53. Triangular stiffening plates 55 and 57 reinforce the connection between base plate 53 and plate 51.

Bearing assembly 37 is bolted to an outer side of the semicircular portion 49 of mounting plate 51, opposite flange 47.

The first axle 41 is received through the bearing assembly 37, in which it rotates, through the semicircular portion 49 of mounting plate 51, through a hole in flange 47 and is finally captured and rotates in forward bearing assembly 39. The second axle 29 is arranged to rotate about the end of first axle 41.

The support arm 21 is pivotally mounted to the second axle 29 by means of opposed bearing assemblies 30, 32 between which opposite ends of axle 29 are rotatably held. It will therefore be realised that the first and second axles allow the support arm to move with two degrees of rotational freedom relative to the mounting box 43.

It will also be realised that the support arm 21 is mounted to mounting box 43 by a pivot assembly 23 (indicated in FIG. 13) comprising the first axle 41 and second axle 29 to which it is pivotally connected. The shaft 9, drive plate 13 and socket 15 comprise one form of a rotary driver for driving the ball 19, and hence the support arm 21 of the fan assembly.

Furthermore, with reference to FIG. 10, the angle of plate 51, arm 21 and hence radial fan 31, relative to mounting box 43 may be adjusted. This is done by rotating the mounting plate 51 about axle 41 and securing it at a desired angle relative to flange 47. The mounting plate 51 can be secured at the desired angle by locating a bolt through corresponding holes 73 in flange 47 and slots 71 (as shown in FIG. 11) in the periphery of the semicircular portion 49 of plate 51.

Accordingly, it is possible to adjust the attitude of the fan 31 so that it sends air out upwardly, downwardly or straight out relative to the mounting box. In making this adjustment it may be necessary to also adjust the height of the ball 19 by sliding it up and down rod 65 as previously discussed.

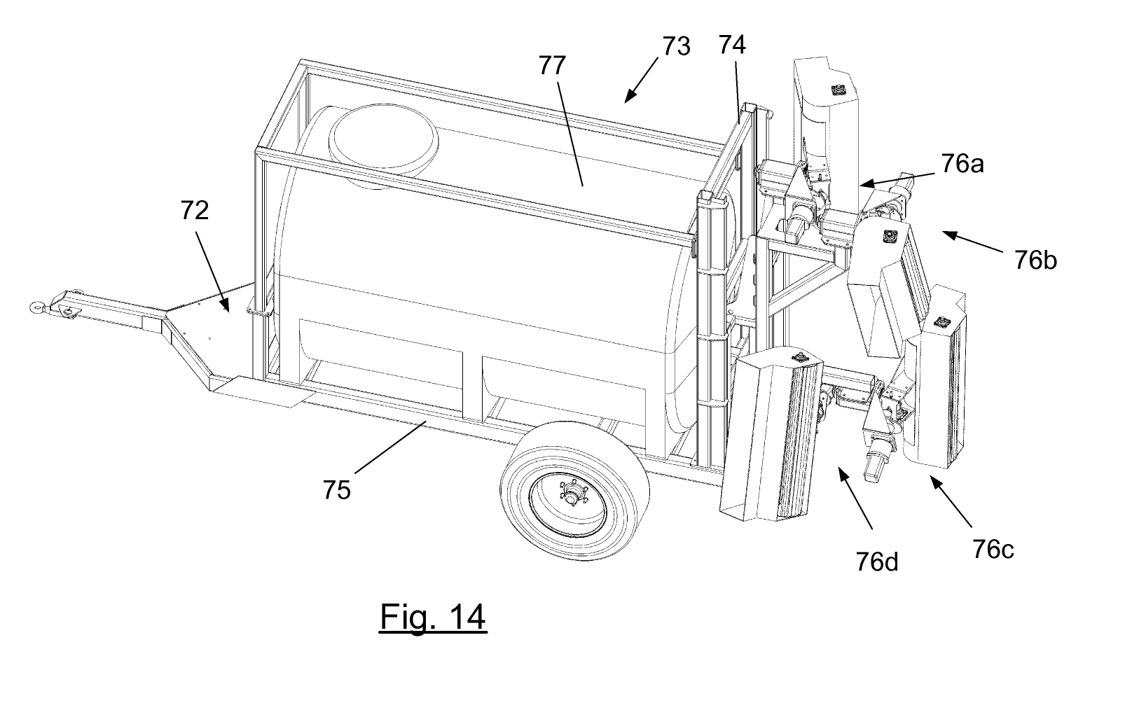

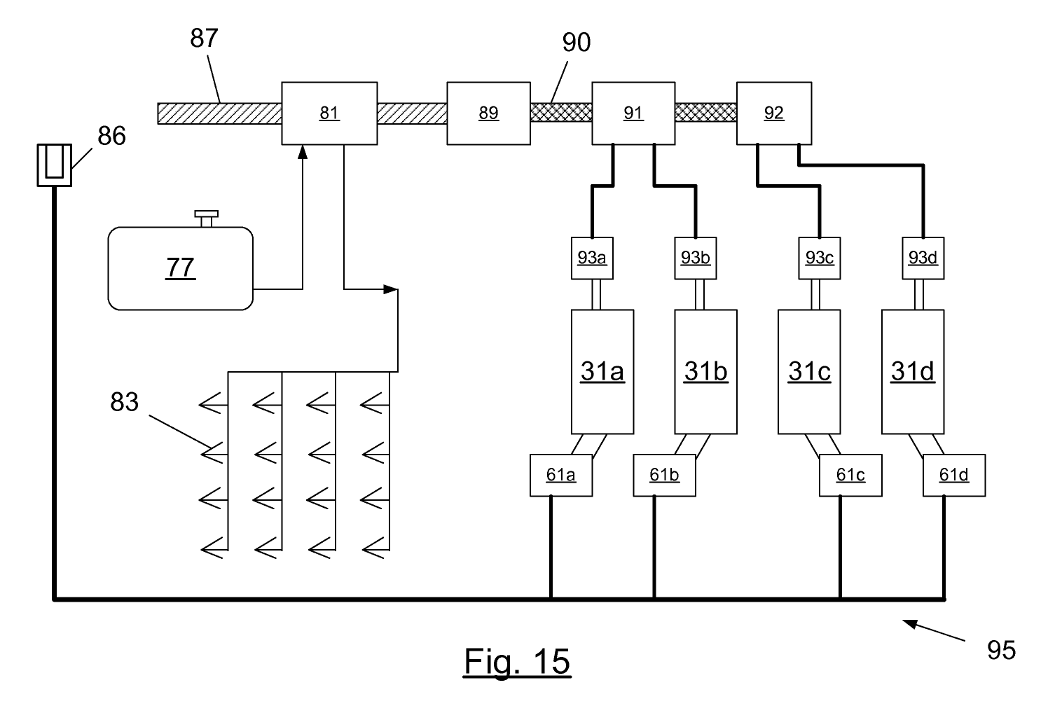

FIGS. 14 and 15 illustrate an orchard sprayer according to an embodiment of the present invention. The orchard sprayer 73 includes a chassis 75 to which there is mounted a tank 77 for holding a liquid solution to be dispersed.

Mounted on a frame 74 at the rear of the chassis 75 are four oscillating fan assemblies 76a, . . . , 76d, of the type described with reference to the second embodiment of FIGS. 9 to 13. In the interests of clarity, the hydraulic motors i.e. item 61 of FIG. 7 and the nozzles 83, for each of the four assemblies are not shown in this drawing.

At the front end of the trailer a mounting plate 72 is provided for placement of various modules as will be described with reference to FIG. 15.

FIG. 15 is a block diagram depicting the sprayer's hydraulic and mechanical drive circuits.

At the front of the sprayer there is mounted a pump 81, which is mechanically powered by an input shaft 87 that is connected to the power take off (PTO) of a towing vehicle, such as a tractor. Pump 81 is in fluid connection between tank 77 and nozzles 83. In use, pump 81 forces chemical solution, e.g. pesticide, from the tank 77 through the nozzles and into the air flow from the centrifugal fans to thereby spray an orchard, for example, with the solution.

The shaft 87 also drives a gear box which increases the rotational speed of the PTO shaft by a ratio of about 1:3. The output shaft from gearbox 89 drives a hydraulic motor 91. The hydraulic motor 91 hydraulically drives four fan motors 93A to 93D which are arranged to mechanically rotate the vanes of the barrel fans 31A, . . . , 31D.

The fans 31A to 31D are oscillated by the mechanical arrangement described with reference to FIGS. 7 to 13 under power of respective hydraulic motors 61A, . . . , 61D. The hydraulic motors 61A, . . . , 61D are hydraulically coupled to fluid lines 95 for connection, by means of connector 86, to a hydraulic power circuit of a towing vehicle in use.

The inventor has found that the previously described orchard sprayer, opens up orchard trees in use, in contrast to prior art sprayers which tended to blow the trees shut. Consequently the air within the tree is more readily replaced with insecticide and pesticide laden air as required.

It will therefore be realized that in a preferred embodiment a fan assembly is provided that includes a centrifugal fan mounted at one end of an arm that is arranged to pivot with at least two degrees of rotational freedom. A rotary driver is coupled to the arm with a ball and socket joint so that the centrifugal fan oscillates in use. The fan assembly may be configured as an orchard sprayer to disburse pesticide into foliage and be mounted to, or towed by, an agricultural vehicle. In use the motion of the fan assists in opening up foliage for improved penetration of the pesticide therein.

While the fan assembly of the present invention has been described in its application to an orchard sprayer, other applications are certainly possible. For example, the fan assembly may be used as an industrial dryer. Furthermore, in a domestic setting it may be advantageous to use an electrically powered small fan assembly according to an embodiment of the invention for cooling, wherein the fan is either a centrifugal fan or axial fan.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

I claim:

1. A fan assembly including:
a support arm mounted to a pivot assembly having at least two degrees of rotational freedom;
a fan mounted to the support arm;
a rotary driver coupled to the support arm for movement thereof about the pivot assembly.

2. A fan assembly according to claim 1, wherein
the fan is mounted to a first end of the support arm and the rotary driver is coupled to the support arm at an opposite second end of the support arm with the pivot assembly located between said first and second ends.

3. A fan assembly according to claim 1, wherein
said pivot assembly includes first and second pivot axles.

4. A fan assembly according to claim 3, wherein the first and second pivot axles are orthogonal to each other.

5. A fan assembly according to claim 3, wherein the pivot assembly is coupled to a frame of the fan assembly via the first axle and wherein the support arm is mounted to the pivot assembly via the second axle.

6. A fan assembly according to claim 1, wherein the rotary driver is coupled to the support arm with a ball and socket joint.

7. A fan assembly according to claim 5, wherein one part of the ball and socket joint is arranged to orbit a rotating driver shaft.

8. A fan assembly according to claim 7, wherein the driver shaft comprises a first output shaft from a gear box.

9. A fan assembly according to claim 7, wherein an input shaft of the gear box is arranged for driving by a hydraulic motor arranged for fluid connection to a hydraulic system of a towing vehicle.

10. A fan assembly according to claim 1, wherein the fan comprises a centrifugal fan.

11. A fan assembly according to claim 1, including fluid outlets located about an airstream outlet side of the fan for dispersing fluid into said airstream during use.

12. An orchard sprayer for mounting to, or towing behind, an agricultural vehicle and including at least one fan assembly according to claim 1.
